(19) United States
(12) Patent Application Publication
(10) Pub. No.: US 2009/0113349 A1
(43) Pub. Date: Apr. 30, 2009

(54) FACILITATING ELECTRONIC COMMERCE VIA A 3D VIRTUAL ENVIRONMENT

(76) Inventors: Mark Zohar, Toronto (CA); Alain Chesnais, Toronto (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/237,189

(22) Filed: Sep. 24, 2008

Related U.S. Application Data
(60) Provisional application No. 60/995,282, filed on Sep. 24, 2007.

(51) Int. Cl. G06F 3/048

(52) U.S. Cl. 715/852

(57) ABSTRACT

A Web-based 3D virtual environment in which users can select a specific virtual object and, in response to that selection, relevant commercial information, such as advertisements, invitations to shop, offers, hyperlinks, or messages in general, that are related to the selected object, are delivered from various electronic commerce engines.

### PRIOR APPLICATION

This Application claims the benefit of U.S. Provisional Application No. 60/995,282, entitled “FACILITATING ELECTRONIC COMMERCE VIA A 3D VIRTUAL ENVIRONMENT,” filed on Sep. 24, 2007, which is incorporated by reference herein in its entirety.

### FIELD OF THE INVENTION

This invention related generally to information technology and, more particularly, to delivering contextually relevant commercial information, from a variety of different sources, via a 3D virtual environment.

### BACKGROUND OF THE INVENTION

The development of the internet of World Wide Web (WWW) created a new way to share and exchange information previously unavailable. Now end-users have the capability to obtain information relating to almost any topic that they choose. With the advent of internet-aware mobile devices, end-users have unprecedented accessibility to the information stored on the internet.

Early in the development of the internet businesses realized that the accessibility of the internet could be utilized to create new business models that leveraged the accessibility of the internet, with the flexibility and power of computing platforms. As a result, new business methods were introduced that leveraged the new technology of the Internet in reducing overhead costs and increasing overall profits. These new business methods and the resultant technologies are now termed e-commerce.

The efficiencies of the new methods have resulted in rapid growth of the sector over the past 10 years. From a business viewpoint, the flexible development models and readily available bandwidth mated with falling hardware costs have made the transition possible if not essential in today's market. From an end-user's viewpoint, increases in online security mated with increased accessibility, variety and communication have lead to increased consumer confidence when shopping online. Some estimate that that electronic commerce will continue to grow, accounting for over 150 billion USD in sales by 2009. The increase in online business transactions is partly due to the increase of available online marketplaces that have been created to sell goods to the increasing numbers of online shoppers. A few of the most prominent examples of online marketplaces are Amazon.com and eBay.com, which are internet sites where end-users may search for and purchase goods securely over the internet.

As more marketplaces come online, shoppers have more options as to where they want to perform their transactions. Thus, new technologies have been developed to allow online retailers to compete for business. Initially, services were developed to help the end-user find a specific product based on user-supplied information. These services would take end-user input describing product terms and output a list of merchants, their prices and alternative fields such as product ratings. Examples of these price-comparison engines include Shopzilla, Google Product Search and Pricewatch.

In addition to these price-based services, web advertising has become more refined and content-specific. Early in the development of the internet, advertisement contracts were based on specific numbers of webpage views, webpage impressions, or banner clicks. Thus, the advertiser had to hope to hit the right demographic by carefully selecting the URL in which to advertise on.

Recently, the development of context-based advertising has lead to advertising based on specific keywords present in the content that is being displayed. Thus, advertisers now can choose keywords present in the content instead of merely the URL in driving their advertisement decisions. Popular examples of service providers with context-based solutions are Google's AdSense, Yahoo! Publisher Network, Microsoft adCenter, and Ad-in-Motion.

The advent of both price-comparison engines and context based advertising has lead to the development of product-oriented sites such as cNet.com and eOpinions.com that cater to the end-user by providing expert and user-entered reviews of products coupled with content-specific advertising and possibly embedded price engines that utilize end-user query search terms to deliver relevant advertising and/or pricing information.

Another technology that has seen marked growth over the past several years is three-dimensional (3D) modeling. With the increases in power of the computer processing unit (CPU) and graphics processing unit (GPU), 3D modeling has become more accessible to businesses and end-users. As a result, there are more vendors offering software packages that allow the viewing and creation of 3D models. Adobe Flash, Apple Quicktime are two popular retail applications capable of viewing 3D objects and there are several open-source 3D viewers available to the end-user. Further, Google Sketchup is a free application that allows users to create and render objects in 3D.

With increased computer speed, increased internet bandwidth and increased web-browser flexibility there has been an increase in the use of the web as a transport medium for 3D models and a migration to the use of 3D modeling in the web sphere. Google's 3D warehouse, for instance, is a repository of 3D models that contains end-user created content. This repository of models allows for easy access to 3D models previously unavailable. Web-browser plugin technology has increased browser flexibility and allowed for 3D models to be viewed from within a standard web browser, such as Internet Explorer. Plugin technology allows for a web browser to send information relating to the rendering of 3D objects to specific applications that are registered with the web browser. When used in this manner, plugins provide end-users increased interaction capabilities in the online space. With the availability of plugin technology, 3D models can be utilized in several online virtual reality environments. ActiveWorlds, for example, offers an electronic shopping experience where users can shop for real and virtual products in a virtual mall from select participating vendors. In this way, 3D modeling applications have been offered as tools to entice consumers into selecting a product from a catalog associated with the modeling application by allowing the user to interactively view the 3D model and place the model in different environments.

The advent of online marketplaces coupled with 3D modeling have created proposed services, such as AsIsKnown, that collect product data of different home textile producers in one system for customer consulting, ordering and overall analyzing of customer behavior. This system proposes to receive orders and profile customer behavior during their decision process. Collected information about the ordered combinations and the user behavior would be analyzed by data- and text mining tools to detect current and future trends in the home textile sector. User product orders and customer analysis would be redirected to specified vendors. In addition to user tracking, this project proposes 3D rendering in its Virtual Interior Designer application that would enable users to model their living space and select textiles from participating vendors.

However, while e-commerce solutions, contextual advertisement on internet webpages and 3D virtual modeling technology has grown independently, there is currently not a solution that is widely-deployable that leverages 3D modeling to enhance users' ability and desire to model 3D environments and import or select products of interest, while providing convenient access to the universe of relevant context-based advertising and e-commerce.

### SUMMARY OF THE INVENTION

One aspect of the invention is directed to deliver contextually relevant information in association with the use of a 3D virtual environment. One example of contextually relevant information is revenue generating advertisements, offers and messages. Other examples include messages, or directed Web content related generally, to electronic commerce. One example of a 3D virtual environment is a room design computer application. Other examples include web-enabled room design applications, online 3D virtual room design applications and online 3D virtual stores allowing a user to browse 3D virtual representations of real goods, virtual worlds, and the like.

Embodiments of the invention are directed towards associating virtual objects and relevant commercial information available from various e-commerce sources on the internet. According to certain embodiments of the invention, specific keywords are associated with virtual objects or collections of virtual objects made available to user navigating the 3D virtual environment. In certain embodiments the specific keywords describe the real world representation of the virtual object. A directed Web content server is used to automatically generate queries for use in one or more e-commerce engines available on the Internet. Associated keywords and optionally, selected demographic data about the end user, is utilized to automatically generate queries for use in one or more e-commerce engines available on the Web. In certain embodiments, the system provides an environment in which users can select a specific virtual object and, in response to that selection, the system automatically delivers relevant commercial information, such as advertisements, invitations to shop, offers, hyperlinks, or messages in general, that are related to the selected object.

In one embodiment, relevant commercial information related to 3D virtual objects utilized in 3D virtual environment applications is obtained from a variety of different sources, including online merchants, online ad servers or other online e-commerce associated applications. The 3D virtual environment application in this embodiment displays the obtained information directly to the user close-in-time to the user's selection of, or demonstrated interest in, the corresponding virtual object, while the user is still interacting with the 3D virtual environment. This close-in-time delivery of contextually-relevant commercial information, along with its display to the user while the user remains engaged with the virtual object can significantly enhance the likelihood that the user will be interested in the delivered information.

Embodiments of the invention provide a versatile web-based platform that is readily adaptable for use in a variety of areas of retail, business-to-business commerce or new and developing markets such as social networking. In certain embodiments of the invention, the end user creates a virtual model of an existing room, area or building. The user then uses the 3D virtual environment application to integrate desirable 3D virtual objects in the virtual model. This 3D virtual model can optionally be viewed by additional end-users such as retailers, companies or businesses, or persons on social networks who may be interested in providing real versions of goods represented by the 3D virtual objects. In these embodiments, the invention provides contextually relevant e-commerce information to these additional end-users.

A system according to one embodiment of the invention facilitates access to existing externally-provided catalogs of 3D virtual objects, such as the Google 3D Warehouse, for example, to enable users to populate 3D scenes using 3D virtual models from those catalogs. The system supports integration of practically any Web-based external catalog that provides the ability to download a 3D model in any standard 3D format and retrieve its associated metadata. The system then provides relevant contextual e-commerce information based on metadata received upon import of the object from the external catalogs. In one embodiment, for example, the system passes contextual information obtained from the external catalog to ad serving software which returns relevant e-commerce information for that object. Thus, the system works with any ad server software that supports the passage of metadata indicating demographics and/or contextual information via an HTTP request to deliver context-sensitive advertising or other relevant e-commerce content.

In one type of embodiment, a computer-implemented system is configured to facilitate user-interactive 3-dimensional (3D) modeling and arranging of virtual objects. The system includes a computer system, such as a client-side PC, for example, that includes a graphical user interface (GUI) that provides user access to a 3D virtual environment application. The computer system further including a network interface device that facilitates communications with the 3D virtual environment application via a computer network, such as the Internet, for example. The 3D virtual environment is adapted to communicate with at least one virtual object database containing 3D virtual models of objects including commercially-available real-world objects.

Through the GUI, the 3D virtual environment facilitates search and retrieval of 3D virtual models in the at least one virtual object database based on at least one user-specified criterion; as well as user selection, virtual placement, and manipulation of individual 3D virtual models from among a set of retrieved 3D virtual models. The search and retrieval can produce a sub-catalog, or palette of virtual models fitting the user's search criteria. These results can be presented in graphical, or even text format. From this sub-catalog or palette, the user can select one or more 3D virtual models for 3D modeling activity.

In response to a user-driven 3D modeling activity utilizing a particular 3D virtual model, such as the user placing a particular 3D model in a 3D virtual modeling space for manipulation, the 3D virtual environment initiates communications over the computer network with at least one merchant computer system that is distinct from the computer system, and obtains commercial information specific to any commercially-available real-world objects corresponding to the particular 3D virtual model. For example, the 3D virtual environment can connect to e-commerce sites such as Ebay, Amazon, Ikea, and the like, and obtain offers to sell, advertisements, coupons, pricing and availability information, and other relevant commercial information to be displayed in the 3D virtual environment (without the user having to independently perform separate Web browsing, and manually formulate and initiate searches using a computer application that is distinct from the 3D virtual environment application). In one embodiment, the system automatically enters queries at the various ecommerce sites. In another embodiment, the system utilizes specially-tailored application programming interfaces (APIs) established with participating merchants in order to obtain the commercial information.

The 3D virtual environment displays the obtained commercial information via the GUI, along with at least one link leading to initiation of a commercial transaction with at least one merchant computer system to purchase any of the commercially-available real-world objects corresponding to the particular 3D virtual model.

Embodiments of the present invention provide users with more directed advertising, by presenting users with links to e-commerce sites and relevant advertising for the 3D virtual objects that they have expressed an interest in. In certain embodiments, the user selects a 3D virtual object, places it in the 3D virtual space and manipulates it until the user's preference is met. Instead of providing broad, general advertising, the irrelevant advertising is filtered out, allowing a more successful and enjoyable shopping experience by providing only the most relevant advertising for the selected 3D virtual object. In this way, various embodiments of the invention allow for browsing of comparable real goods based on 3D virtual objects, direct links to real versions of 3D virtual objects, and context-aware advertising related to the 3D virtual objects.

### BRIEF DESCRIPTION OF THE DRAWINGS

The invention may be more completely understood in consideration of the following detailed description of various embodiments of the invention in connection with the accompanying drawings, in which:

FIGS. 1 and 2 are each a screen shot representing a 3D virtual environment according to one aspect of the invention.

FIG. 3 is a diagram illustrating an example of a hierarchical arrangement of catalogs of 3D virtual objects, or models, and the models themselves, according to one embodiment of the invention.

FIG. 4 is a block diagram illustrating a system architecture according to one embodiment of the invention.

FIGS. 5 and 6 are screen shots illustrating external 3D virtual model catalog search and download according to one embodiment of the invention.

FIGS. 7 and 8 are additional screen shots representing a 3D virtual environment according to one aspect of the invention.

FIG. 9 is a screen shot representing search results from a search performed at an ecommerce site and displayed within a 3D virtual environment in response to a user's interaction via the 3D virtual environment according to one embodiment of the invention.

FIG. 10 is a block diagram illustrating a client-side interaction with a 3D virtual environment according to one embodiment of the invention.

FIG. 11 is a block diagram illustrating a server-side process according to one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENTS

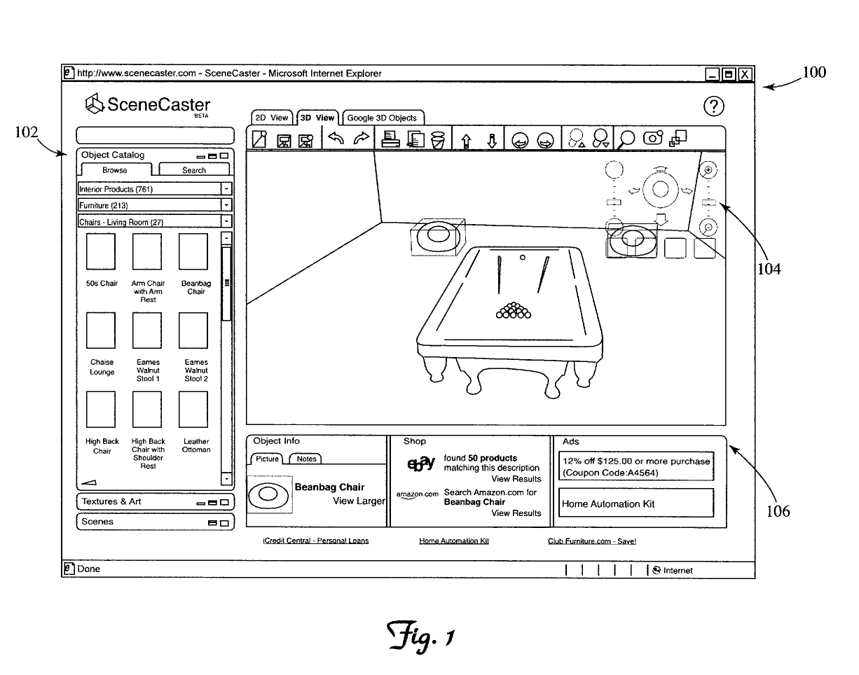

The scene illustrated in FIG. 1 depicts one embodiment of the present invention, a screen shot of a 3D virtual scene of a room with certain objects situated therein. The screen shot of FIG. 1 represents the state of the 3D virtual environment in response to an end-user's inserting 3D objects into the 3D scene. In the present example, each of the objects in the 3D scene has associated metadata. The virtual object has metadata that is associated with it. For instance, in the present example, the metadata can simply be the text string “beanbag chair.” Further, in the present example, the metadata associated with the 3D object allows for the presentation of context-sensitive information relating to the objects. This context-sensitive information may include object information relating to the physical embodiment of the 3D object, hypertext links to online marketplaces where the item of interest can be purchased and advertisements related to the object. In the present example, the user may choose to find beanbag chairs at Amazon.com or eBay.com. Alternatively, the end-user may explore the advertisements for alternative products or special deals on related products.

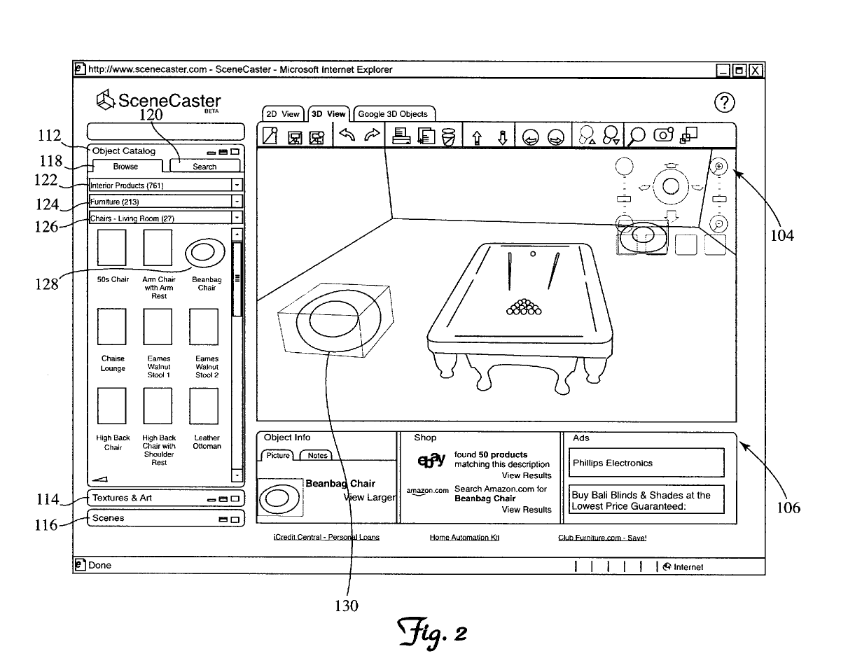

Referring to FIG. 2, one embodiment of the invention is a web-enabled 3D virtual environment portal. Embodiments of the present invention are capable of being run within a standard web browser 100. Thus, in certain embodiments of the present invention the portal is run in Windows Explorer, Mozilla Firefox, Apple Safari and Opera web browsers. However, one having skill in the art will recognize that the portal could be run in any web browser that supports plugin technology. In one embodiment, the portal comprises three main user interface (UI) areas: the object selection pane 102, the main 3D virtual environment interaction area 104, and the information and commerce pane 106. One having skill in the art will recognize that in alternate embodiments the UI may be altered to provide for increased accessibility both by alternate devices and by persons with special needs. More specifically, persons having skill in the art will recognize that the portal may be run on mobile devices such as Apple iPod and iPhone or the Nokia N810 internet tablet. Further persons having skill in the art will recognize that the UI may be altered to allow for persons with disabilities increased access to the application.

Referring now to FIG. 2, in certain embodiments, the object selection pane 102 allows the end user to quickly find 3D models of interest. Certain embodiments allow the end user to search for 3D objects in the object catalog 112. Embodiments allow the user to utilize a browse tab 118 to narrow down the available objects. In this example, the system categorizes objects in a step-down fashion and displays them in the browse tab. For instance, the end-user may choose a very broad category, such as interior products 122 and then further refine the available objects by selecting subcategories such as Furniture 124 and Chairs—Living Room 126. One having skill in the art will recognize that the 3D virtual objects may be categorized in a variety of different ways and may be in several different categories without deviating from the current invention. Alternate embodiments allow the user to use a search tab 120 to enter in product keywords and search for 3D models within the model database. Further in some embodiments, the user may find various textures and art from the Textures and Art menu item 114. In still other embodiments the user may want to select pre-made or user-made 3D virtual scenes 116 in which to add the virtual objects. In certain embodiments, once the user selects a 3D virtual object 128 from the object catalog 112, they can drag and drop the item into the 3D virtual environment interaction area 104 which will then display the 3D object 130. For instance, the user may select the 3D virtual object of a “bean bag” and place it in the corner of the 3D virtual scene where it would be used if placed in an actual depiction of the virtual space.

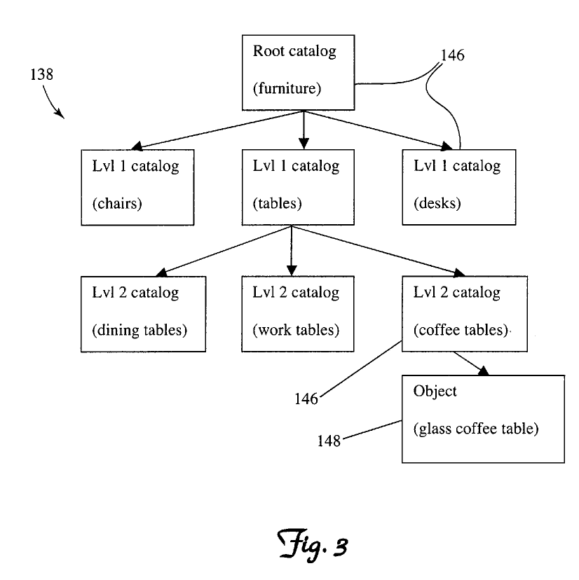

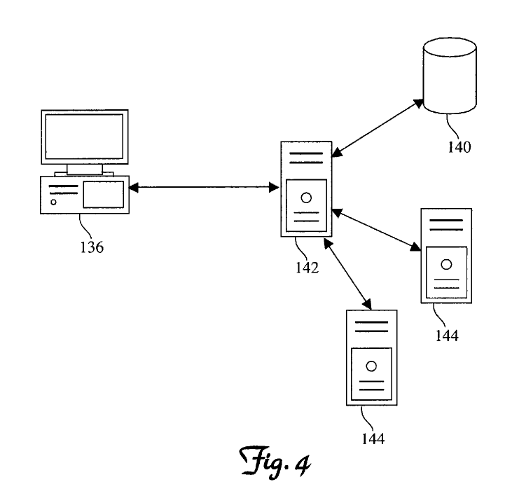

Referring now to FIG. 3 and FIG. 4, the cataloging of a collection of 3D objects available to the user in the object selection pane 102 of the client 136 is displayed. In various embodiments, 3D virtual objects will be stored as records 138 in a database 140 which will store object information for use in the portal application run on a web server 142 witch drives the interaction with available ad servers 144. The database may be a relational database such as MySQL, SQL Server, Postgres, Ingres or Oracle. Those having skill in the art will appreciate that there are several other databases in which the current invention may be applied. In one embodiment, the 3D objects stored in the database are arranged in a hierarchical catalog structure as depicted in FIG. 3. In this embodiment, the database 140 contains records 138 that are either catalog records 146 or 3D object records 148. Each catalog record 146 and 3D object record 148 can have tags or additional information specified as metadata. In the embodiment shown in FIG. 3 the metadata information is shown in parenthesis. One having skill in the art will recognize that metadata can be any information relating to the object of the record, including but not limited to name, size, color, use, lifespan, weight, height and the like. Further, one having skill in the art will recognize that the records 138 in the database 140 may be organized in a variety of relationships in order to increase performance of database 140 queries.

Related embodiments allow for the use of the HTTP protocol to access externally provided catalogs for use in populating 3D scenes. For example one such system operates with virtual objects stored on an external service that allows for the association of tags with each object, such as, for example, the Google 3D warehouse. Each object stored in the warehouse is considered to be part of a virtual catalog associated with the Google service that covers all of the objects stored in it. The technique described above is then applied to that virtual catalog. The approach provided by aspects of the present invention provides significant versatility in that a variety of different external services can be provided and easily utilized with the 3D virtual environment, without the need for custom-created 3D models specifically for use with the application. The system may be configured to allow access to virtual objects that are either pre-cataloged, or non-pre-cataloged (i.e., not organized with other related virtual objects in a common database or data structure). In one example embodiment, the system provides a search service for locating virtual objects not present in catalogs for which the application has been configured by default, and automatically cataloging those objects in a new or selected virtual object catalog or collection.

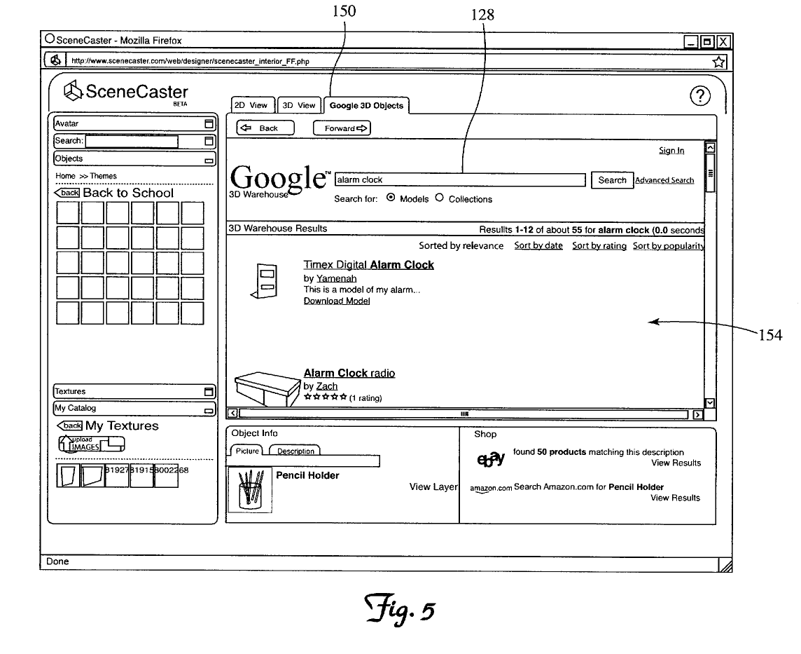

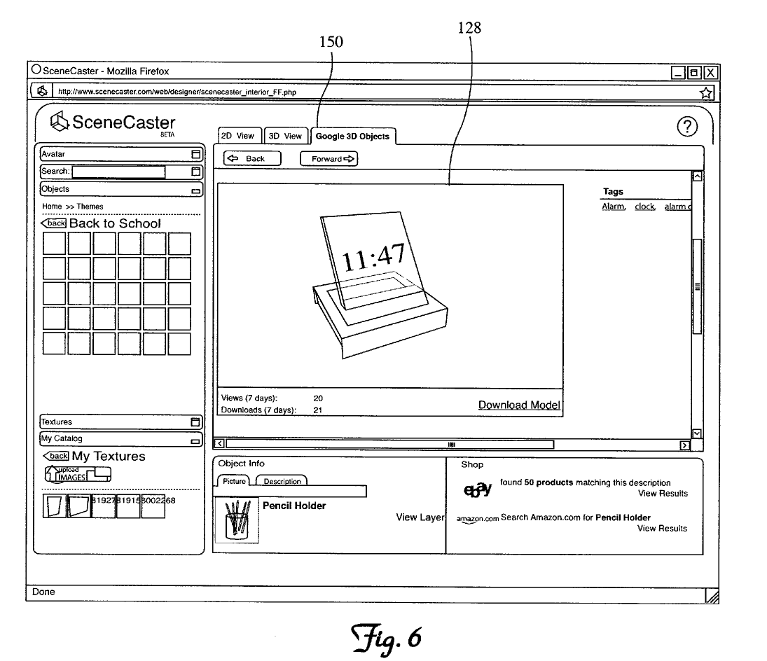

For instance, the system allows a user to select a specific external 3D virtual object database tab 150 as depicted in FIG. 5 and FIG. 6. The user can then enter in keywords in available search fields 152 provided by the system in order to search the external virtual catalogs for 3D virtual models of interest. From the search results 154 the system facilitates user selection of a 3D virtual model of interest 156 to download. Upon initiating download of the selected 3D virtual model of interest 156, the system will first query the external catalog for metadata relating to the selected object. This query is performed in one example by utilizing an external API presented by the external object catalog. Alternatively, the metadata is obtained by analyzing the metadata on the object information page returned by the external catalog during the end-user's search. One having skill in the art will appreciate that metadata may be obtained by “screen-scraping,” or analysis of HTML returned by the external catalog. Once retrieved, the metadata of the external object is stored locally. In this way, any web based external catalog that provides the ability to download a 3D model in any standard 3D format and retrieve associated metadata through the World Wide Web can successfully be integrated with this system.

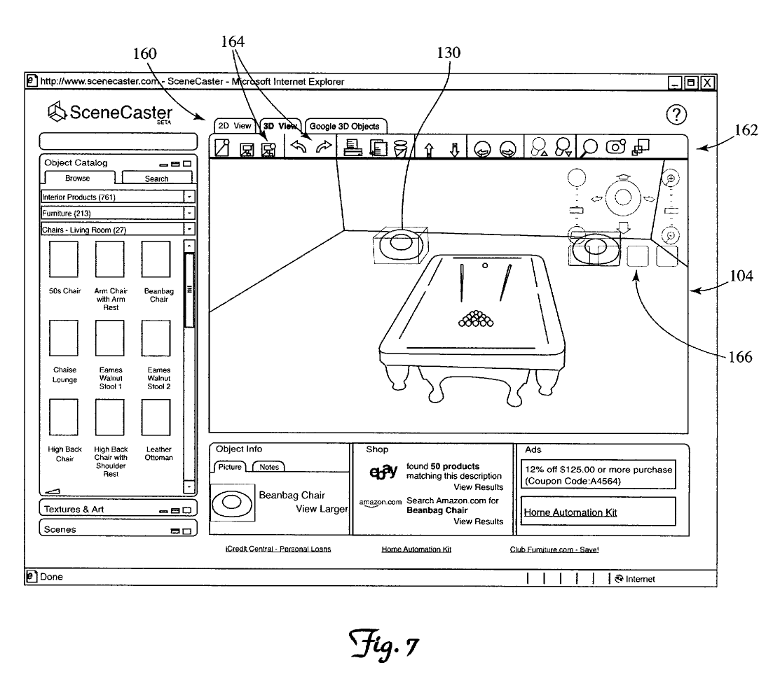

Aspects of invention allow users to interact with 3D virtual objects 130 selected from the object selection pane 102 and placed in the 3D virtual environment interaction area 104 as depicted in FIG. 7. In certain embodiments, the 3D virtual environment interaction area has several UI elements that enable different views of the virtual space 160. For example, there may be a two dimensional view and a 3D view. Persons having skill in the art will recognize that new tabs may be added to identify and enable additional views of the virtual space. The virtual interaction area may also contain a control bar 162 that contains several UI buttons 164 that control the preferences of the virtual interaction area 104. These buttons may control zoom, pitch, roll, or may allow for saving, printing, or deleting. Persons having skill in the art will understand that buttons may be added and removed to enable or disable functionality contained in the virtual interaction area 104. In addition to UI buttons 164 on the control bar 162 in various embodiments the system may provide an additional control compass 166 to enable direct manipulation of a selected 3D object 130 within the virtual interaction area 104. This control compass 166 controls zoom, size, pitch, and roll of the selected 3D object 130. For instance, by utilizing the control compass 166 the user places each 3D virtual object 130 in a preferred place and orientation within the virtual interaction area 104.

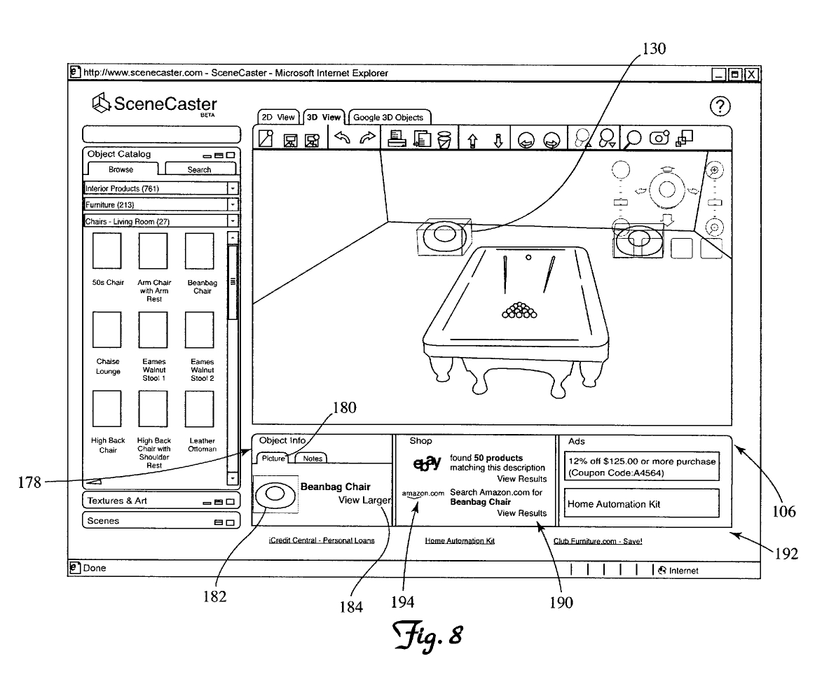

Now referring to FIG. 8, some embodiments of the invention contain an information and commerce pane 106. The information and commerce pane 106 includes an object information section 178 that displays information relating to a selected 3D virtual object 130. The object information section 178 includes a picture tab 180, which provides a two dimensional picture of the object 182 and provides a link 184 to a larger version of the picture. In addition the object information section 178 includes a notes tab 186 that will provide the end-user with additional information about the 3D virtual object 130.

Certain embodiments of the invention contain a shop information section 190 and an advertisement information section 192. The shop information section 190 includes links to external online marketplaces 194. In one embodiment, a directed Web content server is used to automatically generate queries that are sent to external marketplaces or e-commerce engines in order to obtain possible tangible product matches for the 3D virtual object 130. Persons having skill in the art will recognize that the generated queries may be constructed in real-time as the user selects a 3D virtual object or they may be pre-generated when the 3D virtual object is added to the database. In one embodiment, external queries are constructed utilizing information pulled from object records, or metadata, stored in a local database combined with requirements of external marketplaces or e-commerce engines for access and, optionally, additional demographic data about the end user. Additional demographic data may include any information received by the system as a result of the user's interaction, including search terms or clicks. In other embodiments, external queries are generated based on requirements of the external Applications Programming Interface (API) maintained by the external e-commerce engine. A popular API, for example, is the one maintained by Amazon Web Services. The system also allows for any ad server software that permits the passage of metadata indicating demographics and/or contextual information via an HTTP request to be used in conjunction with this invention to deliver context sensitive ads. For instance, the system can pass metadata to Google Adsense which will then return context sensitive advertising in response.

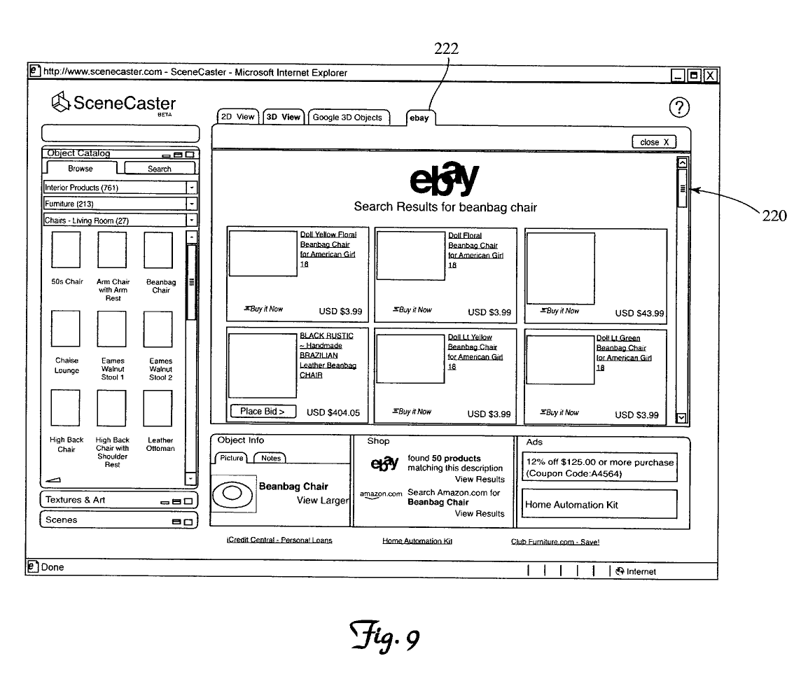

In this way, the system queries allow the end user to purchase a similar or equivalent tangible representation of the 3D virtual product almost immediately after utilizing or selecting 3D virtual object. An example of such is illustrated in FIG. 9, where the end-user, after selecting the bean bag 3D virtual object in the 3D virtual environment interaction area, activated the context-sensitive eBay link. As a result, the eBay commerce engine results for “beanbag chair” are displayed 220 and a tab 222 is displayed to allow the user to easily switch between the available functions of the present invention. In a general sense, this operation is an example wherein the system provides an environment in which users can select a specific virtual object. In response to the user's selection of that object, the system automatically drives the delivery of directed Web content, such as advertisements, offers, or messages that are related to the selected object.

One method that embodies the invention includes utilizing a computer process that walks the object/catalog tree as depicted in FIG. 3 to its root and accumulates the tags that are encountered. The set of tags that has been thus accumulated, along with demographic data associated with the user, are formatted and sent to an ad server which, in turn, returns targeted contextual ads that are relevant to the selection the user has made. These contextual ads can be displayed to the user within the application.

In other embodiments, the system supports user selection of several of the 3D virtual objects, or the entire 3D virtual “scene.” In these embodiments the system performs the same way, driving the delivery of directed Web content based on data analysis of the selected objects or the entire scene. For example, when selections or collections consist of more than one object, the intersection of all the metadata tags encountered on each object in the set is utilized. For instance, if Object A has the tags (furniture, chair, arm chair) and object B has the tags (furniture, chair, kitchen chair), the resulting collection of tags that is sent to the ad server would be (furniture, chair). The resulting tag set thus corresponds to the tags that are present in each of the selected objects in a collection. Alternatively, the union of the metadata tags may be used, resulting in a tag set that includes all tag information.

Additional embodiments drive the delivery of directed Web content by keeping track of the last manipulated 3D virtual object within the 3D virtual scene. For instance, if the 3D virtual environment includes both a 3D virtual bean bag and a 3D virtual chair which was last manipulated by the user, in certain embodiments the system would display links and advertising directed towards the 3D virtual chair.

In other embodiments, the system delivers directed Wed content by keeping track of how long a 3D virtual object stays within the 3D virtual scene. For example, if the 3D virtual scene contains a 3D virtual bean bag, a 3D virtual chair and a 3D virtual table, but the table was first added and has not been removed, while the other 3D virtual objects have been added and removed, certain embodiments of the invention would display links and advertising directed towards the 3D virtual table.

Optionally, the contextual ads include active links that permit the user to initiate a transaction with a certain merchant conducting the advertising. In this regard, this embodiment of the invention links the user's actions that are indicative of the user's interest level in a particular virtual item to an e-commerce engine through which the user can purchase the real item represented by the virtual item of the 3D virtual environment.

In one type of embodiment, once the system recognizes user interest in a particular 3D virtual model, the 3D virtual environment application transmits a request to an e-commerce site to identify other comparable products. In this regard, the system can enable a comparison shopping experience for the user. In a related embodiment, the 3D virtual environment application utilizes information returned from the e-commerce site on comparable products to search for 3D virtual models of those comparison products. The two-way interface with the e-commerce engines and with the 3D virtual model catalogs, enables users to quickly and seamlessly try different, products in their virtual environment without having to perform the extra steps of searching for comparable products and locating or making models for those products. In this way, the system provides a mechanism for obtaining new models from sources other than the catalogs of 3D virtual objects with which the 3D virtual application may have been pre-configured. According to aspects of the invention, fast, seamless, and automatic provision of contextually relevant 3D models and ecommerce information and links create and foster a pleasant and satisfying user experience that encourages the user to enter into an e-commerce transaction.

In another type of embodiment, the 3D virtual environment application generates an e-shopping guide based on the 3D model of interest to the user. The e-shopping guide can be built “behind the scenes” while the user explores different 3D virtual objects without interruption. Later, the user can view and interact with the e-shopping guide to shop for, and purchase products of interest without actually having to navigate the Web to perform the research and comparison shopping.

For example, the e-shopping guide can be in an interactive report format that would provide product ratings, reviews, and the like; comparison shopping info from a variety of merchants; spec sheets, owner's manuals, and similar info; discussion forum content concerning the product; any safety recall information; similar information pertaining to various accessories needed or commonly purchased for use with the product. The output can be a comprehensive, packaged, and interactive customized web page that contains, summarizes, or easily links to, every item of information for the user and to merchants.

Various embodiments of invention can be monetized in a multitude of ways. In alternate embodiments, vendors of goods may obtain the ability to pay to host their catalog of objects, with associated metadata, on an internal database. For example, a furniture vendor pays to place 3D virtual objects of their goods in the database, thus when a user selects a vendor's 3D virtual object, only a link to that vendor's e-commerce site is displayed. Other embodiments allow vendors to pay to display relevant information on the information and commerce pane 106. Still other embodiments allow vendors to bid for placement of context aware links to their own e-commerce site. For example, a vendor could bid for placement of links in the shop information section 190. Certain embodiments give vendors the ability to pay to post context sensitive ads in the right hand part of the information and commerce pane 106. For example, a furniture vendor may pay to have a link to their e-commerce site display when a user selects a 3D virtual model of a high-backed dining chair.

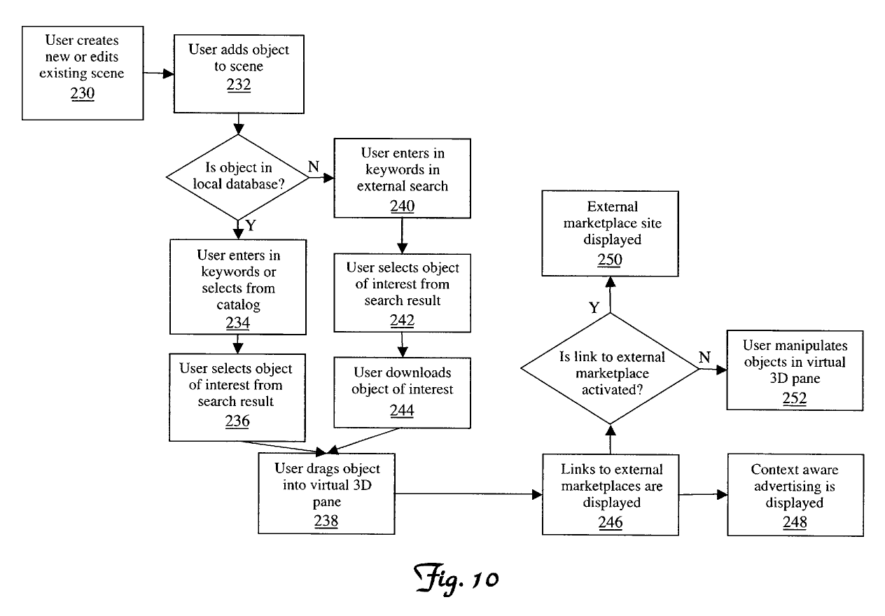

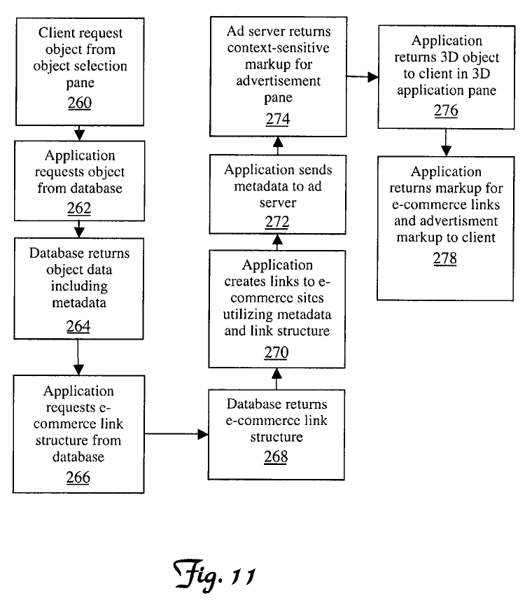

The operation according to one aspect of the present invention is illustrated in FIGS. 10 and 11. In one embodiment a user interacting with the client creates a new 3D virtual scene or selects an existing scene from a list of pre-defined or previously saved scenes 230. The user then chooses to add a 3D virtual object into the 3D virtual scene 232. The user selects a 3D virtual object from a local 3D object database, or an external 3D object database. In one embodiment, the user selects a 3D virtual object from the local database by entering keywords into a search box which queries the local database based on the search terms or utilizes a series of drop downs to limit the available 3D objects in the database 234. The user then selects the 3D virtual object from the search results 236 and places the 3D virtual object in the 3D virtual pane 238. In another embodiment, the user selects a 3D virtual object from an external library by entering in query terms or keywords into a search box provided by the external 3D library displayed within the client 240. The user then selects an object of interest from the search result list provided by the external library 242. The user then selects to download the object of interest 244 and places the object in the 3D virtual pane 238. Upon download and display of the selected 3D virtual object, links to external marketplaces are displayed on the client 246. The links include direct links to external marketplaces providing the user with options to purchase real versions of the 3D virtual object. In one embodiment advertising relating to the selected 3D virtual object is displayed 248. In one embodiment the user activates one of the displayed links and the client displays the external marketplace site 250 allowing the user to purchase real versions of the 3D virtual object. In another embodiment the user manipulates the 3D virtual object within the 3D virtual scene 252.

In one embodiment the client interacts with the application server by requesting a 3D virtual object from the object selection pane 260. The server then queries the 3D virtual object database for the correct 3D virtual object record 262. The database, in response to the query, returns the 3D virtual object record to the application server 264. The object record includes all data associated with the object, including metadata associated with the 3D virtual object. The application server then requests the appropriate link structure from the database 266. The database responds by returning the e-commerce link structure requested by the application server 268. In various embodiments the returned link structure is determined by which external marketplaces have paid to have links placed, or paid for objects to be stored in the database. The application server then creates the links to e-commerce sites by integrating the metadata returned by the database query into the link structure 270. The application server then sends the metadata returned by the database query to an external ad server 272 in order to obtain context aware advertising for the selected 3D object. The ad server responds by sending context-sensitive advertising markup 274. In various embodiments the ad server returns HTML code, xHTML code, image files or a mixture of images and code. The application server then returns the retrieved information to the client, including 3D virtual object information 276 and e-commerce links and advertisement markup 278.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A computer-implemented system configured to facilitate user-interactive 3-dimensional (3D) modeling and arranging of virtual objects, the system comprising:
a computer system including a graphical user interface (GUI) that provides user access to a 3D virtual environment application, the computer system further including a network interface device that facilitates communications with the 3D virtual environment application via a computer network;
the 3D virtual environment being adapted to:
communicate with at least one virtual object database containing 3D virtual models of objects including commercially-available real-world objects;
facilitate, via the GUI, search and retrieval of 3D virtual models in the at least one virtual object database based on at least one user-specified criterion;
facilitate, via the GUI, display, user selection, virtual placement, and manipulation of individual 3D virtual models from among a set of retrieved 3D virtual models;
in response to a user-driven 3D modeling activity utilizing a particular 3D virtual model, initiate communications over the computer network with at least one merchant computer system that is distinct from the computer system, and obtain from the at least one merchant computer system commercial information specific to any commercially-available real-world objects corresponding to the particular 3D virtual model;
display the commercial information via the GUI; and
display, via the GUI, at least one link leading to initiation of a commercial transaction with at least one merchant computer system to purchase any of the commercially-available real-world objects corresponding to the particular 3D virtual model.
